(19) United States
(12) Patent Application Publication
(10) Pub. No.: US 2005/0131916 A1
(43) Pub. Date: Jun. 16, 2005

(54) System and method for storing discussion threaded relationships

(75) Inventors: Mustansir Banatwala, Hudson, NH (US); Richard Gorzela, Andover, MA (US)

Correspondence Address: Stephen T. Keohane, Esq.;Patent and Trademark Counsel, Lotus Software, IBM Corporation, 1 Rogers Street, Cambridge, MA, 02142, US

(73) Assignee: International Business Machines Corporation, Armonk, NY (US)

(21) Appl. No.: 10/737,575

(22) Filed: Dec. 16, 2003

(51) Int. Cl. G06F 17/00

(52) U.S. Cl. 707/100

(57) ABSTRACT

A system for storing discussion threaded relationships includes a character map tree model tree for representing relationships of a topic and its descendent responses; an adjacency model for storing for each node in the tree a next key, a parent key, and root identifier; and an application server responsive to the character map tree model and adjacency model for selectively retrieving a topic and all descendants, including their relationships, creating a response and adding it as a child to a topic or response, deleting a topic or response and all its descendants, and retrieving topics in a folder.

### BACKGROUND OF THE INVENTION

1. Technical Field of the Invention

This invention relates to discussion threaded relationships in a relational database using adjacency and character map tree models.

2. Background Art

An example of a threaded discussion application is a Google news group, a type of application often referred to as a discussion forum. In a typical discussion forum, a topic is posted and people respond. The responses in such a discussion forum create a response hierarchy.

Documents in threaded discussions conceptually form tree relationships. There are a number of ways to represent tree relationships in a relational database, e.g. Adjacency Model, Nested Set Model, and Character Tree Map Model.

The different approaches to representing trees in a relational database each provide different advantages and disadvantages with regard to operational efficiency. Some typical tree operations include: adding a child, finding a topic and all its descendants, finding all roots, and so forth. These correspond to the discussion forum operations: entering a response document, finding a topic and all responses (including their relationships), deleting a topic and all its responses, and finding all topics. Applying the Adjacency Model alone can result in expensive recursive query operations on topics and responses, e.g. delete. Applying the Nested Set Model alone can also result in expensive operations, e.g. adding a response may result in many records updated. Applying the Character Tree Map Model alone may unduly restrict the number of topics.

Character Tree Map Model is described in U.S. patent application Ser. No. 10/326,187, filed 20 Dec. 2002 for “Method, System, and Program Product for Managing Hierarchical Structure Data Items in a Database”. Nested Set Model of Trees is described in Joe Celko, “SQL for Smarties” in DBMS Online, March 1996. He also describes the advantages and disadvantages of the Adjacency Model.

Referring to FIG. 1, a typical discussion forum 26 on the web is illustrated. A person posts a topic, and persons post responses. No hierarchy is of responses is presented, and a reader must use some other approach for determining the relevance or relationships of a given response to prior responses.

Referring to FIG. 2, a prior art hierarchy is illustrated. In such a hierarchy, a linked list enables a person to know what is being responded to. An identifier 20 is assigned to each topic and response 24. Also provided for each response is a parent identifier 22 which enables a user to determine that this response, for example response 2″ (ID 20=5) is responding to response 2′ (parent ID 22=4).

To reconstruct the hierarchy 24 of FIG. 2, there is this problem: because data is stored as shown in FIG. 2, there is no easy way extract a portion of the database. If a sort is made on ID 20 in the example of FIG. 2, this would work—but usually IDs 20 are random and have no sort property. In that case it is not possible to sort by ID 20 to get hierarchy shown in FIG. 2, but would rather get a flat list 28, as is illustrated in FIG. 3. In this case, the thread is not maintained as a hierarchy.

Consequently, a partial solution is to keep ID 20 and parent ID 22 in database from which to reconstruct the thread of topics and responses. This reconstruction takes processing time, which may be intolerably long for large discussion threads. The entire tree must be searched each time a user requests a thread reconstruction. The search time is unbounded: that is, as responses are added to the thread and entered to the table of IDs 20 and parent IDs 22, an ever larger database must be recursively processed with each insertion or inquiry.

### SUMMARY OF THE INVENTION

A method, system, and program storage device for storing discussion threaded relationships by representing in a character map tree model tree relationships of a topic and its descendent responses in a discussion thread; storing for each node in the tree in accordance with an adjacency model a node key, a next key, a parent key, and root identifier; and with reference to the character map tree model and adjacency model, selectively retrieve a topic and all descendants, including their relationships, creating a response and adding it as a child to a topic or response, deleting a topic or response and all its descendants, and retrieving topics in a folder.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 illustrates a typical discussion forum.

FIG. 2 illustrates a linked list hierarchy.

FIG. 3 illustrates a flat file, non-hierarchical thread.

FIG. 4 is a schematic representation of a system environment for implementation of preferred embodiments of the invention.

FIG. 5 is a schematic representation of a discussion forum database in accordance with the preferred embodiments of the invention.

FIG. 6 is a high level system diagram illustrating a program storage device readable by a machine, tangibly embodying a program of instructions executable by a machine to perform method steps for storing threaded discussions.

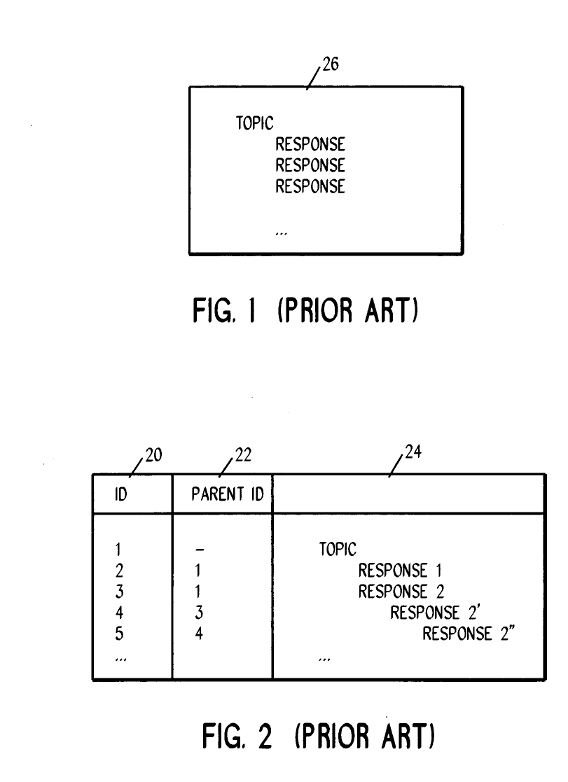

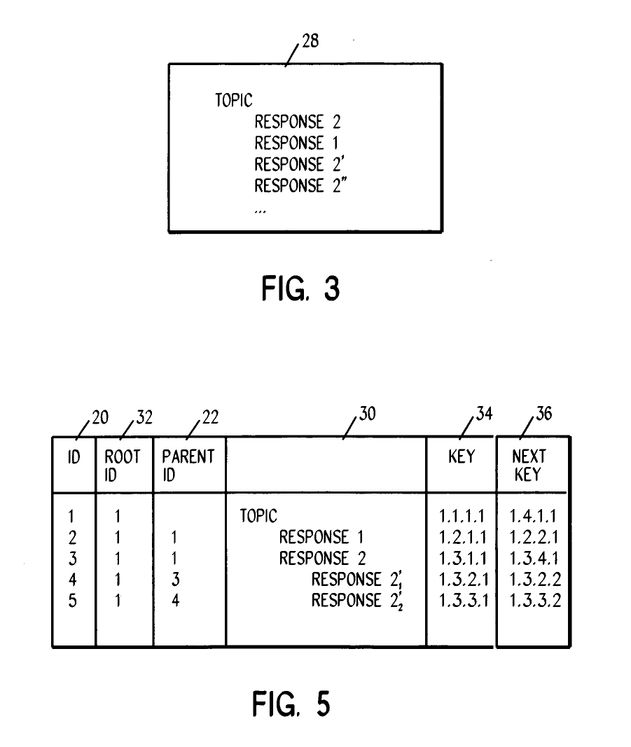

### BEST MODE FOR CARRYING OUT THE INVENTION

The present invention relates to an efficient database implementation of threaded discussions in a relation database.

Given some typical discussion forum characteristics, the present invention takes advantage of aspects of both the Character Tree Map Model and Adjacency Model to provide an efficient relational database implementation with regard to common discussion forum operations.

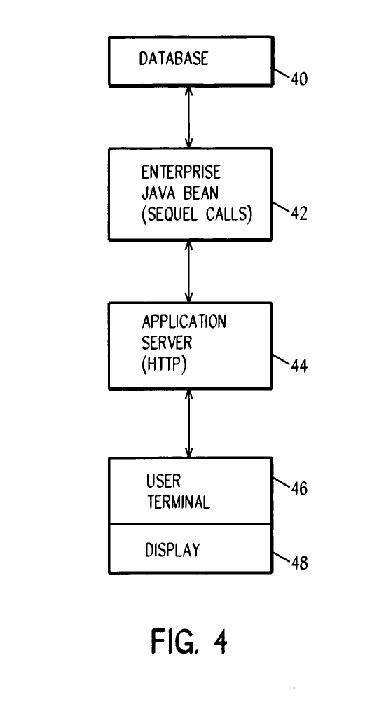

Referring to FIG. 4, user at terminal 46 with a display 48 sends a create topic request to HTTP server 44. Server 44 determines that there is an enterprize java bean (EJB) handler for this request, and issues servlet calls to EJB 42, which in turns accesses database 40 through Sequel (SQL) calls or, alternatively, Java database connectivity (JDBC) layer calls. The EJB, HTTP servers represent an exemplary embodiment, others of which will be apparent to those of skill in the art.

The Character Map Tree Model is used to represent the tree relationship of a topic and all its descendants. This provides for efficient operations over other approaches for topic deletion and adding a new response to a topic. Move and copy of responses and their descendants are uncommon operations for discussion forms. The Character Map Tree Model is used to bound response level depth, and the maximum number of direct descendants a response may have, but the model can be implemented in a way that this is not prohibitive for discussion forums. The Adjacency Model is used, in part, to distinguish between topic and response trees, which efficiently provides parent information in query results and efficiently identifies topics in a forum. This adjacency information is not used, however, to implement operations such as delete, or retrieving a topic and all its responses since this can result in expensive operations.

Thus, this invention uses the Charater Map Tree Model (CMT) to represent the tree relationship of a topic and all its descendants. The CMT model uses a single fixed-length character field to represent the position of a given node within the tree hierarchy. This character field, designated herein as NDXKEY, uniquely identifies a node within a tree, identifies the node's parents at all preceding levels, provides a range of all the node's children, indicates the level of a given node within a tree, can specify an ordering, and provides efficient query operations.

The CMT model does bound the number of nodes at a given level and the number of nodes at any level, but this is controlled by the size of the character field, the character set used, and the number of characters used per level. For discussion forum applications, these parameters can be set to give satisfactory limits. For example, using a key of length 256, a character set [A-z], and two characters per level, the number of levels will be restricted to 128, and the number of direct response to 3,364. A key length of 256 or less can also be indexed on major relational database implementations, such as DB2, SQL Server, Oracle, and so forth.

This invention uses, in part, the Adjacency Model by storing with a node not only the NDXKEY, but also the parent and root ID's. The relationship columns within a table are defined as (lengths are implementation specific):
NDXKEY VARCHAR(255) CMT character field for this node
PARENTID VARCHAR(32) ID of the parent of this node
ROOTID VARCHAR(32) ID of the root of this node
NEXTNDXKEY VARCHAR(255) NDXKEY to use for the next child of this node

The PARENTID is part of the result set for operations such as getAllChildren, but is not used logically to implement the operations.

By this implementation, since the NDXKEY is only unique within a tree (topic and its descendants), not globally for a set of topics, ROOTID is used to uniquely associate a response to a topic. Alternatively, keys could be generated starting with a folder (group of topics), but this would bound the number of topics allowed within a folder, usually an undesirable characteristic for a discussion forum.

Referring to FIG. 5, an exemplary embodiment of the discussion forum 30 of the invention is illustrated. As in the prior art, each topic is given an ID 20, and each response an ID 20 and parent ID 22. To these are added by the present invention a root ID 32, a key 34 and a next key 36. Through these fields, each inserted response is given a position in a thread.

By way of example, for topic 1.1.1.1, a first response adds one to the second digit, giving 1.2.1.1. The second response adds one to the second digit of the largest previous response 1.2.1.1, yielding 1.3.1.1. This same processing occurs when adding further sub-responses to the thread: one is added to the third digit, and so forth, as is illustrated in FIG. 4, column 34. With this approach, it is now possible to sort by key 34 in response to a request from a user for a thread listing. The key (map, or index) for the response is created at the time it is inserted into the tree.

If keys are based on integers 0-9, only 10 responses to a given parent response may be inserted to the tree. However, if the sort order A-Z, a-z, 0-9 is used, then 26+26+10=62 keys are available. If multiple digits are used with separators, even more response are possible.

The above works. However, there is yet another consideration. When creating a next entry to the tree, it is necessary to search for a maximum key 34, and then increment it by one. When creating an object, users are generally more lenient with the time it takes than when viewing. Therefore, in order to minimize read time at the expense of insertion time, a next key field 36 is provided. This makes a parent responsible for farming out a next key to a direct descendent. When a topic or response gives out a key for a next response, it increments its next key 36 by one in anticipation of a next request. Upon request, now the highest key need not be searched from column 34 and incremented to obtain the next key, but is immediately available from next key 36.

If FIG. 5 is collapsed, next key 36 column can be used to generate for display in the collapsed mode with the title 30 the number of children for each topic. This is obtained by subtracting one from the appropriate digit position of next key 36. Next key 36 is not obtained or discovered by searching all of the database, but is obtained by accessing the parent title or response 30.

In the embodiment of FIG. 5, legacy information is maintained: ID 20 and parent ID 22, for walking up and down the tree. To this may be added root topic ID field 32. This root topic ID field 32 enables a fast walk-up to a topic from any descendent response. Now, for any response, traversal of the tree up or down is facilitated.

In accordance with the present invention, several exemplary operations are provided and described in the following tables:
Table 1 Retrieve a topic and all descendants, including their relationships.
Table 2 Create a response and add it as a child to a topic or response.
Table 3 Delete a topic or response and all its descendants.
Table 4 Retrieve the topics in a folder.

The tables for a topic/response meta-data, properties, and relationships data can be implemented in many different and acceptable ways. The operation descriptions hereafter make some assumptions to simplify the description in order to demonstrate the benefits of the method. The main point to demonstrate is how the main discussion forum operations can be made efficient by using the data model previously described.

TABLE 1
Retrieve a topic and all its descendants

```
Parameter:  rootid
SELECT meta-data/properties, parentid, NDXKEY FROM
DocumentTables
    WHERE ( ROOTID = rootid )
    ORDER BY NDXKEY
```

TABLE 2
Create a response and add it as a child to a topic or response.

| Parameters: | parentid of the parent of the response |
|---|---|
| | response object |
| if (parentid is not null){ | |
| parent = | findByid( parentid ) // error if parent |
| | not found |
| rootid = | parent.getRootid( ) |

```
    if (rootid is null) { // set the parent as the
        root since this is the first child for this
        root
    parent.setRootid = parentid
    parent.setNDXKEY = initial ndxkey value
}
if (parent.getNextNDXKEY( ) is null) { // set the
parent's next ndskey since this is the first child
for this node
    Parent.setNextNDXKEY = parent.getNDXKEY +
    initial level character segment
}
response.setRootid = parent.getRootid
response.setNDXKEY = parent.getNextNDXKEY
response.parentid = parentid
nextNDXKEY = derived from parent.getNextNDKEY
parent.setNextNDXKEY = nextNDXKEY
if (parent.getRoot( )! = parentid)
    root = findByidForUpdate( )
else
    root = parent
//set any attrs on root that are needed here, e.g.
response count, etc., then do the updates
if (parent ! = root)
    update(root)
update(parent)
}
```

TABLE 3
Delete a topic/response and all its responses

```
Parameters = resource object to delete
parentid = resource.getParentid
rootid = resource.getRootid
ndxkey = resource.getNDXKEY
if(rootid ! = null) {
    Descendants = findResourcesByQuery(...) // Use CMT
    based query to get all the descendants of the
    resource
    //iterate through descendants and check for
    permission to delete.  If not adequate, error
    delete(descendants)
    if (resource.getid( )  != rootid){
    //update any attrs on the root that are needed
    here, e.g. response count, etc.
    }
}
delete(resource)
```

TABLE 4
Retrieve the topics in a folder

| | |
|---|---|
| Parameter = | folderid is the id of the folder |
| | containing the topics |

```
SELECT meta-data/properties  FROM DocumentTables
    WHERE PARENTID IS NULL
        AND
            PATH = folderID
    ORDER BY OrderColumn
```

In accordance with a further aspect of the invention, the requirement of maintaining locks on topics and responses at a global, database wide, level is alleviated by using parent ID 22 as the control for updates. Such a lock is now required on the immediate parent only for the time required to update next key 36 and give it out to the requester. Previously, the entire table needed to be locked throughout the update operation. Thus, referring to FIG. 5, supposing that a response 3 comes in at the same level as response 2. Instead of locking the entire database, topic ID 1 is locked long enough to give out next key 36 1.4.1.1 to the first request and update next key 36 to 1.5.1.1 in anticipation of a next request.

### Alternative Embodiments

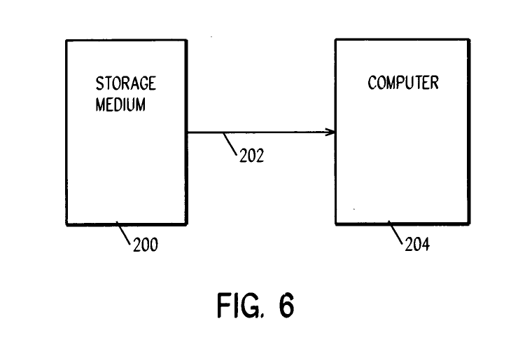

It will be appreciated that, although specific embodiments of the invention have been described herein for purposes of illustration, various modifications may be made without departing from the spirit and scope of the invention. Referring to FIG. 6, in particular, it is within the scope of the invention to provide a computer program product or program element, or a program storage or memory device 200 such as a solid or fluid transmission medium, magnetic or optical wire, tape or disc, or the like, for storing signals readable by a machine as is illustrated by line 202, for controlling the operation of a computer 204, such as a host system or storage controller, according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

1. A method for storing discussion threaded relationships, comprising:
representing in a character map tree model tree relationships of a topic and its descendent responses in a discussion thread;
storing for each node in said tree in accordance with an adjacency model a node key, a next key, a parent key, and root identifier; and
with reference to said character map tree model and said adjacency model, selectively retrieve a topic and all descendants, including their relationships, creating a response and adding it as a child to a topic or response, deleting a topic or response and all its descendants, and retrieving topics in a folder.

2. The method of claim 1, further comprising locking said parent key as control for updates to said discussion thread.

3. The method of claim 1, further comprising sorting said discussion thread by said node key in response to a request from a user for a thread listing.

4. The method of claim 2, further comprising responsive to a request to enter a response to a node of said tree, providing to said response said next key as said node key for said response, and incrementing said next key by one in anticipation of a next request.

5. The method of claim 4, further comprising:
collapsing said tree to topics;
generating from said next key a number of children of each said topic by subtracting one from the appropriate digit position of said next key; and
displaying for each said topic said number of children.

6. A system for storing discussion threaded relationships, comprising:
a character map tree model tree for representing relationships of a topic and its descendent responses;
an adjacency model for storing for each node in said tree a next key, a parent key, and root identifier; and
an application server responsive to said character map tree model and said adjacency model for selectively retrieving a topic and all descendants, including their relationships, creating a response and adding it as a child to a topic or response, deleting a topic or response and all its descendants, and retrieving topics in a folder.

7. The system of claim 6, further comprising a lock on said parent key for controlling updates to said discussion thread.

8. The system of claim 6, further comprising a thread listing generated by sorting said discussion thread by said node key in response to a request from a user for said thread listing.

9. The system of claim 7, said next key responsive to a request to enter a response to a node of said tree for serving as said node key for said response; said next key thereupon being incremented by one for anticipating a next request.

10. The system of claim 9, further comprising:
collapsing said tree to topics;
generating from said next key a number of children of each said topic by subtracting one from the appropriate digit position of said next key; and
displaying for each said topic said number of children.

11. A program storage device readable by a machine, tangibly embodying a program of instructions executable by a machine to perform method steps for storing discussion threaded relationships, said method comprising:
representing in a character map tree model tree relationships of a topic and its descendent responses;
storing for each node in said tree in accordance with an adjacency model a next key, a parent key, and root identifier; and
with reference to said character map tree model and said adjacency model, selectively retrieve a topic and all descendants, including their relationships, creating a response and adding it as a child to a topic or response, deleting a topic or response and all its descendants, and retrieving topics in a folder.

12. The program storage device of claim 11, said method further comprising locking said parent key as control for updates to said discussion thread.

13. The program storage device of claim 11, said method further comprising sorting said discussion thread by said node key in response to a request from a user for a thread listing.

14. The program storage device of claim 12, said method further comprising responsive to a request to enter a response to a node of said tree, providing to said response said next key as said node key for said response, and incrementing said next key by one in anticipation of a next request.

15. The program storage device of claim 14, said method further comprising:
collapsing said tree to topics;
generating from said next key a number of children of each said topic by subtracting one from the appropriate digit position of said next key; and
displaying for each said topic said number of children.

16. A computer program product for storing discussion threaded relationships according to the method comprising:
representing in a character map tree model tree relationships of a topic and its descendent responses;
storing for each node in said tree in accordance with an adjacency model a next key, a parent key, and root identifier; and
with reference to said character map tree model and said adjacency model, selectively retrieve a topic and all descendants, including their relationships, creating a response and adding it as a child to a topic or response, deleting a topic or response and all its descendants, and retrieving topics in a folder.
